(19) United States
(12) Patent Application Publication
(10) Pub. No.: US 2011/0002369 A1
(43) Pub. Date: Jan. 6, 2011

(54) IP TO ANALOG CONVERTER

(75) Inventors: Jeffrey P. Davis, East Bethel, MN (US); Kevin Sanh Hong, St. Paul, MN (US)

Correspondence Address: SCHWEGMAN, LUNDBERG & WOESSNER, P.A., P.O. BOX 2938, MINNEAPOLIS, MN, 55402, US

(73) Assignee: MultiTech Systems, Inc., Mounds View, MN (US)

(21) Appl. No.: 12/498,054

(22) Filed: Jul. 6, 2009

(51) Int. Cl. H04B 1/38

(52) U.S. Cl. 375/222

(57) ABSTRACT

A device includes an analog front end, a converter processor, and a network port. The analog front end includes a first modem configured to couple to a first line of a modem bank and includes a second modem configured to couple to a second line of the modem bank. The modem bank is configured to couple to a host processor. The first modem is operable independent of the second modem. The converter processor is coupled to the analog front end. The network port is coupled to the converter processor and configured to communicate with a network. The converter processor is configured to execute instructions to exchange data between the network and the modem bank.

### BACKGROUND

Current technology for wirelessly communicating with a number of remote devices is inadequate. In particular, analog modems have used the public switched telephone network (PSTN) to communicate with an analog remote device. One example of a remote device includes an automatic teller machine (ATM) such as that placed by a financial institution.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 includes a block diagram of a system according to one example.

FIG. 2 includes a block diagram of a portion of a system according to one example.

FIG. 3 includes a flow chart of a method corresponding to one example.

### DETAILED DESCRIPTION

An enterprise may use a PSTN-based analog communication system to communicate with a number of analog devices. The enterprise, such as a financial institution, a municipal utility provider, or vending machine operator may communicate with a number of remotely installed machines such as ATM machines, a remote utility meters, or vending machines, respectively.

In these examples, the remote device, such as the ATM machine, is equipped with an analog modem and is coupled to the PSTN by a wired connector carrying analog signals. The enterprise uses a modem bank or modem pool to communicate with each of the various remote devices. A host processor can be coupled to the modem bank which is then coupled to a plurality of analog communication lines. The analog communication lines can include T1 trunk lines, a PRI line, or other analog service.

Communication routing between the remote device and the modem bank is managed by the PTSN using the dial-up telephone number for the respective devices. In various examples, the remote device, the modern bank, or either the remote device and the modem bank can initiate a call to the other.

The data communicated between the modem bank and the remote device can include, for example, device status information, error reporting, and troubleshooting.

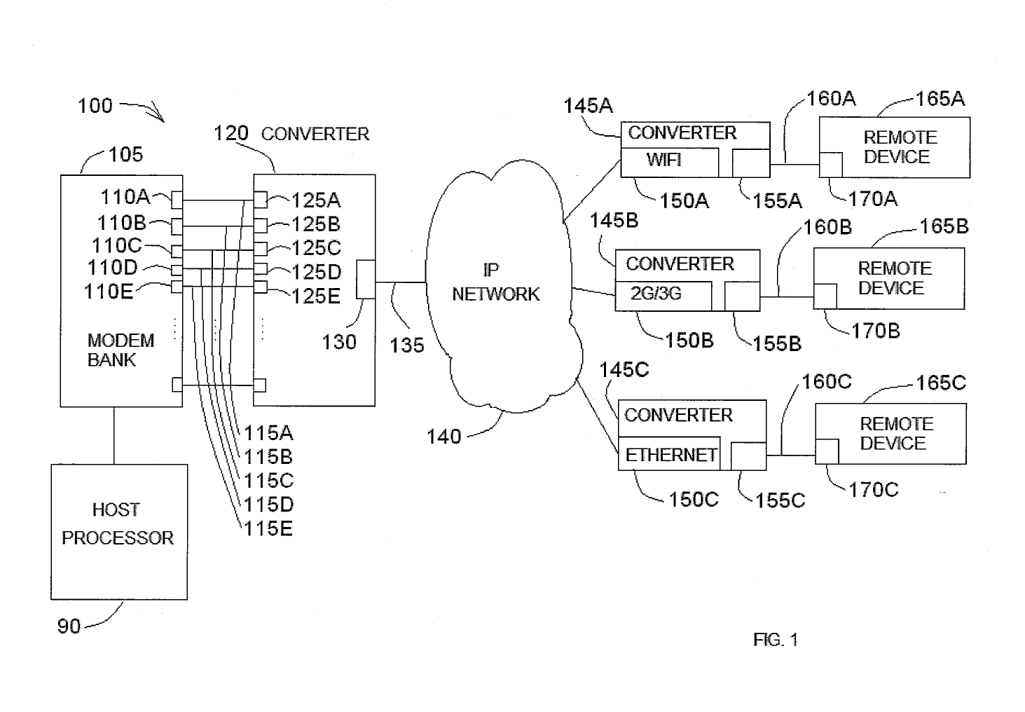

FIG. 1 illustrates an example of system 100 that provides an interface to couple analog modems of modem bank 105 with analog remote devices, here denoted as three such devices 165A, 165B, and 165C. The figure illustrates a particular number of devices, modems and other elements, however, it is to be understood that more or less than those shown can also be used. For example, the ellipses near analog modems of converter 120 denote that any number of such elements may be present in a particular example.

System 100 includes host processor 90 coupled to modem bank 105, either or both of which can be located at a host facility such as a financial institution or other enterprise. Modem bank 105 is operated under the control of host processor 90. Host processor 90 provides instructions for operating the individual modems of modem bank 105. Modem bank 105 includes a number of individual analog modems, here denoted as modems 110A, 110B, 110C, 110D, and 110E. Each modem of modem bank 105 is coupled by an analog line to a corresponding analog modem of converter 120 in one-to-one alignment. For example, analog modem 110A of modem bank 105 is coupled by analog line 115A to modem 125A of converter 120. In similar manner, modems 110B, 110C, 110D, and 110E are coupled to modem 125B, 125C, 125D, and 125E by analog lines 115B, 115C, 115D, and 115E, respectively. Analog lines 115A-115E can include a two line or four line conductor suitable for communicating analog telephone signals. In one example, lines 115A-115E includes an RJ-11 cable with an RJ-11 connector.

Modem 110A is operable independent of modem 110B, modem 110C, and all other modems. As such, a message conveyed on one line of analog communication is separate from any other message conveyed on any other analog communication line.

Converter 120 can be co-located at a facility of the enterprise. In one example modem bank 105 and converter 120 are rack mounted.

Converter 120 is configured to convert a message between IP protocol communication and analog communication. In the figure, converter 120 includes module 130 coupled to IP network 140 by channel 135. Channel 135 can include a communication link, such as WiFi, a 2G link, a 3G link, a 4G link, or an Ethernet link. Other communication links are also contemplated. Module 130 is configured to communicate between the analog modems 125A-125E and IP network 140 using the particular link provided. Module 130, sometimes called a network port, can include, for example, a radio frequency (RF) antenna configured to communicate wirelessly with IP network 140. In various examples, module 130 communicates a digitally encoded signal.

IP network 140 carries packet switched digital data using a network communication protocol such as IP protocol. For example, IP network 140 can include the internet or a wide area network. Various elements of IP network 140 can be configured for either wired or wireless communication.

IP network 140 is coupled to individual converters such as converter 145A, 145B, and 145C. Converters 145A, 145B, and 145C each includes a module to allow coupling with IP network 140. For example, converter 145A includes module 150A configured as a WiFi interface to couple with IP network 140. Similarly, converters 145B and 145C include module 150B and 150C configured to communicate using 2G/3G and an Ethernet protocol, as shown in the illustrated example.

In addition, each of converters 145A-C includes an analog modem 155A, 155B, and 155C, respectively. Modems 155A, 155B, and 155C are coupled by a wired link 160A, 160B, and 160C to modem 170A, modem 170B, and modem 170C of remote device 165A, 165B, and 165C, respectively. A modem, such as modem 155A and modem 170A, can include a wired connector (such as an RJ-11 connector) or a wireless telephone link (using, by way of examples, an RF antenna or an infrared link).

As noted elsewhere in this document, remote devices 165A, 165B, and 165C can include an ATM machine, a utility meter, a vending machine or other remote device. Additional examples include point of sale equipment, equipment at a remote processing facility, or other such equipment.

Converter 120 can be compared to each of converters 145A, 145B, and 145C. Analog modem 125A of converter 120, for example, is similar to analog modem 155A of converter 145A. Module 130 of converter 120 performs a role similar to that of module 150A of converter 145A. In addition, converter 120 and converter 145A, for example, each includes a processor coupled to an analog modem and a module.

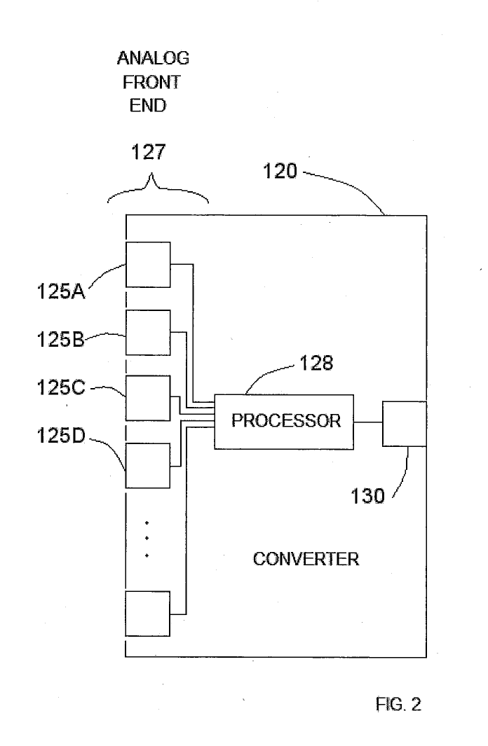

FIG. 2 illustrates a block diagram of converter 120. In general, the description of converter 120 also can be applied to converters 145A, 145B, and 145C.

In the example shown, converter 120 includes modems 125A, 125B, 125C, and 125D with ellipses indicating that any number of modems can be used. Modems 125A, 125B, 125C, and 125D are collective represented as analog front end 127. Analog front end 127 is coupled to processor 128. Processor 128 can include any combination of hardware, firmware, and software. In various examples, processor 128 includes an analog processor or a digital processor. In various examples, processor 128 includes memory configured for storing instructions and data. For example, processor 128 can implement instructions to exchange data between network 140 and any of the plurality of modems.

Processor 128 is coupled to module 130. Module 130, as described elsewhere in this document, is configured to communicate with IP network 140. Converter 120 can be powered by a battery or a connection to a metered line service. Metered line service is variously referred to as mains, household power, household electricity, domestic power, wall power, line power, AC power, city power, and grid power. A metered line service can be provided by an electric grid including, for example, household electric service at a nominal level of 110 V AC.

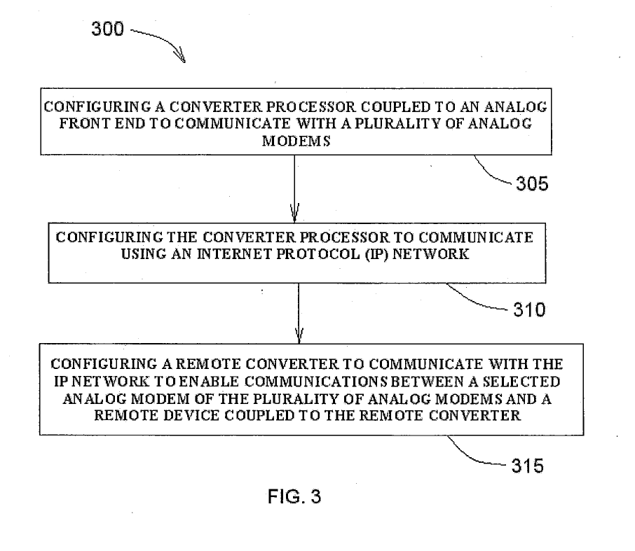

FIG. 3 illustrates method 300 implemented by one example of the present subject matter. Method 300 includes, at 305, configuring a converter processor coupled to an analog front end to communicate with a plurality of analog modems.

Processor 128 (FIG. 2) illustrates an example of a converter processor. At 310, method 300 includes configuring the converter processor to communicate using an Internet Protocol (IP) network. This can include receiving instructions from another device, from a user, or from stored data.

At 315, method 300 includes configuring a remote converter to communicate with the IP network to enable communications between a selected analog modem of the plurality of analog modems and a remote device coupled to the remote converter.

In one example, a host processor is coupled to the plurality of analog modems and a signal (such as a message) can be communicated between the host processor and a remote device that is coupled to the particular remote converter. In one example, configuring the converter processor to communicate using the IP network includes configuring to communicate using a cellular network. In one example, method 300 includes configuring the converter processor to implement a data security algorithm, a data encryption algorithm, or an authentication algorithm.

The present subject matter enables the modem bank and each remote device to operate as though each were coupled directly to the PSTN when in fact, each is coupled to a converter that communicates digital data using an IP network.

System 100, as shown in FIG. 1 can be used to control and monitor a plurality of remote devices in which a portion of the communication is conducted using digital data and the ends of the communication path include analog communication. The portion conducted using digital data can include the internet. For example, a bank of analog modems at a management facility can be interfaced to a plurality of analog remotely located devices. The remote devices can include consumer-operated equipment such as ATM machines, vending machines, or other devices that can be operated using remote management. In various examples, the communication over the network can be uni-directional (from the remote device to the host processor or from the host processor to the remote device) or bi-directional. Various communication protocols can be implemented for initiating and conducting a communication session. In addition, the host processor can be configured to remotely interrogate, diagnose, or otherwise provide services to a remote device. The remote devices can be of various types and supplied by various manufacturers.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A device comprising:
a plurality of analog modems including a first modem configured to couple to a first line of a modem bank and including a second modem configured to couple to a second line of the modem bank, the modem bank configured to couple to a host processor, the first modem operable independent of the second modem;
a converter processor coupled to the plurality of analog modems; and
a network port coupled to the converter processor and configured to communicate with a network, the converter processor configured to execute instructions to exchange data between the network and the plurality of analog modems.

2. The device of claim 1 further including an antenna coupled to the network port.

3. The device of claim 1 wherein the network port includes at least one of a WiFi network port, a 2G network port, a 3G network port, a 4G network port, and an Ethernet port.

4. The device of claim 1 further including a plurality of connectors configured to couple with an RJ-11 cable, the plurality of connectors corresponding in one-to-one relation with the plurality of analog modems.

5. The device of claim 1 wherein the first line and the second line are configured to communicate an analog signal.

6. The device of claim 1 wherein the network port is configured to communicate a digital signal.

7. A device comprising:
a network port configured to communicate with a network;
a processor coupled to the network port; and
a modem coupled to the processor and configured to couple to a telephone connector of a remote device, the processor configured to execute instructions to exchange data between the network port and the modem and to facilitate communications between the network and the remote device.

8. The device of claim 7 wherein the network port is configured to communicate a digital signal.

9. The device of claim 7 wherein the network port includes at least one of a WiFi network port, a 2G network port, a 3G network port, a 4G network port, and an Ethernet port.

10. The device of claim 7 wherein the network port includes an RF antenna.

11. The device of claim 7 wherein the modem includes an analog modem.

12. The device of claim 7 wherein the modem includes a connector configured to couple with an RJ-11 cable.

13. A system comprising:
a first device having a plurality of analog modems, a first processor, and a first network port, the plurality of analog modems including a first modem configured to couple to a first line of a modem bank and including a second modem configured to couple to a second line of the modem bank, the modem bank coupled to a host processor, the first modem operable independent of the second modem, the plurality of analog modems coupled to the first processor, and the first processor coupled to the first network port, the first network port configured to communicate with a network, the first processor configured to execute instructions to exchange data between the first network port and the plurality of analog modems;
a second device having a second network port, a second processor, and a remote modem, the second network port configured to communicate with the network, the second processor coupled to the second network port and coupled to the remote modem, the second processor configured to execute instructions to exchange data between the second network port and the remote modem, the remote modem configured to couple to a telephone connector of a remote device and facilitate communications between the host processor and the remote device.

14. The system of claim 13 wherein the first network port is configured to couple with at least one of a cellular network and an Internet Protocol (IP) network.

15. The system of claim 13 wherein the first network port is configured to couple with a radio frequency (RF) antenna.

16. The system of claim 13 wherein the first network port includes an RF antenna.

17. The system of claim 13 wherein the first network port includes at least one of a WiFi network port, a 2G network port, a 3G network port, a 4G network port, and an Ethernet port.

18. The system of claim 13 wherein the first device includes a plurality of connectors configured to couple with an RJ-11 cable, the plurality of connectors corresponding in one-to-one relation with the plurality of analog modems.

19. The system of claim 13 wherein the second network port includes at least one of a WiFi network port, a 2G network port, a 3G network port, a 4G network port, and an Ethernet port.

20. The system of claim 13 wherein the second network port includes an RF antenna.

21. The system of claim 13 wherein the remote modem includes an analog modem.

22. The system of claim 13 wherein the remote modem includes a connector configured to couple with an RJ-11 cable.

23. A method comprising:
configuring a converter processor coupled to an analog front end to communicate with a plurality of analog modems;
configuring the converter processor to communicate using an Internet Protocol (IP) network; and
configuring a remote converter to communicate with the IP network to enable communications between a selected analog modem of the plurality of analog modems and a remote device coupled to the remote converter.

24. The method of claim 23 wherein a host processor is coupled to the plurality of analog modems and further including communicating a signal between the host processor and the remote device.

25. The method of claim 23 wherein configuring the converter processor to communicate using the IP network includes configuring to communicate using a cellular network.

26. The method of claim 23 further including configuring the converter processor to implement a data security algorithm.

27. The method of claim 23 further including configuring the converter processor to implement a data encryption algorithm.

28. The method of claim 23 further including configuring the converter processor to implement an authentication algorithm.
